(19) United States
(12) Patent Application Publication
(10) Pub. No.: US 2019/0036768 A1
(43) Pub. Date: Jan. 31, 2019

(54) ALTERATION PROCEDURE GENERATION SYSTEM, ALTERATION PROCEDURE GENERATION METHOD, AND PROGRAM STORAGE MEDIUM

(71) Applicant: NEC Corporation, Minato-ku, Tokyo (JP)

(72) Inventor: Toshio TONOUCHI, Tokyo (JP)

(73) Assignee: NEC Corporation, Minato-ku, Tokyo (JP)

(21) Appl. No.: 16/073,379

(22) PCT Filed: Feb. 7, 2017
(86) PCT No.: PCT/JP2017/004319

§ 371 Date: Jul. 27, 2018

(30) Foreign Application Priority Data
Feb. 8, 2016 (JP) 2016-021604

(51) Int. Cl. H04L 12/24; H04L 29/08

(52) U.S. Cl. CPC H04L 41/082; H04L 41/0853; H04L 67/1031; H04L 41/142; H04L 67/025; H04L 41/0873

(57) ABSTRACT

The present invention provides an alteration procedure generation system, etc., with which it is possible to appropriately generate an alteration procedure for a system in which a dependence relationship exists between attributes constituting the system. This alteration procedure generation system includes a calculation means for adding, to a sum total of the number of procedures per attribute that are required for alteration of the attribute value of an attribute constituting a system that is in a prescribed state to the attribute value of the attribute constituting the system that in an intended state to which to be altered, the number of attributes less than a prescribed value that the attribute values of other attributes are altered by the alteration, and subtracting the prescribed value from the sum total, thereby calculating an estimated arrival distance.

This application is a National Stage Entry of PCT/JP2017/004319 filed on Feb. 7, 2017, which claims priority from Japanese Patent Application 2016-021604 filed on Feb. 8, 2016, the contents of all of which are incorporated herein by reference, in their entirety.

### TECHNICAL FIELD

The present invention relates to an alteration procedure generation system, an alteration procedure generation method, and an alteration procedure generation program. Particularly, the present invention relates to an alteration procedure generation system, an alteration procedure generation method, and an alteration procedure generation program, being capable of generating an alteration procedure of a system configuration at a high speed.

### BACKGROUND ART

A configuration of an information and communication technology (ICT) system constituted by computers and a communication network that connects the computers in such a way as to enable communication therebetween is altered along with a change of a request and a change of an external environment.

For example, when a load on the ICT system increases, a server is added to the ICT system. Moreover, when a version of a library of software is updated, a version of a library introduced in a computer equipped with an application program using the library to be updated is also required to be updated.

PTL 1 describes a general system configuration alteration device which updates an ICT system as described above. FIG. 11 is a block diagram illustrating a configuration example of a general system configuration alteration device.

When a system alteration instruction is output from a system alteration instruction unit, the system configuration alteration device illustrated in FIG. 11 searches for a procedure in which an inter-function dependence rule unit has a dependence relationship, and executes the procedure that has been searched for, in order to achieve the system alteration indicated by the instruction. For example, when an update processing of a version of a software library is executed, an update processing of versions of other libraries on which the library to be updated depends is also executed.

When a dependence relationship existing between components constituting a system such as the software library described above is simple, an alteration procedure of a system configuration can be easily obtained. The system configuration is altered on the basis of the obtained alteration procedure. However, when a system is constituted by a large number of components such as software, a server, and a communication network, it is difficult to obtain an alteration procedure while considering each dependence relationship existing between components.

FIG. 12 is an explanatory diagram illustrating an example of a dependence relationship in a Web system. (a) in FIG. 12 is an explanatory diagram illustrating a configuration example of the Web system. As illustrated in (a) in FIG. 12, a Web server is activated in an operating system (OS). Moreover, the Web server utilizes a library lib being loaded on the OS and having a version v1 (hereinafter, referred to as lib v1). In addition, a plurality of APs which are Web applications and have a version v1(hereinafter, referred to as AP v1) are operating on the Web server.

(b) in FIG. 12 is an explanatory diagram illustrating a transition of a state of each component illustrated in (a) in FIG. 12, and a dependence relationship existing between states. A full-line arrow illustrated in (b) in FIG. 12 represents a transition of a state. For example, a state of the AP v1 makes a transition in an order of “operating”, “inactive”, and “unloaded”.

Furthermore, a broken-line arrow illustrated in (b) in FIG. 12 represents a dependence relationship existing between states. For example, the states “inactive” and “unloaded” of the AP v1 are realized when a state of the Web server is “active”.

In light of the above, in the Web system illustrated in (a) in FIG. 12, a work procedure is considered with reference to (b) in FIG. 12, in the case where a version of an AP being a Web application is updated to v2 from v1, i.e., in the case where an Ap v2 is substituted for the AP v1. Note that, when operating as in (b) in FIG. 12, the Ap v2 uses a lib v2 being a lib having a version v2, instead of the lib v1.

In order to substitute the Ap v2 for the AP v1, a administrator of the Web system first inactivates the AP v1. After inactivation, the administrator uninstalls the AP v1 from the Web server, and brings a state of the Web server to a state in which the AP v1 is not loaded. Note that, as illustrated in (b) in FIG. 12, the work described above is executed under a condition that the Web server is in an active state.

Then, the administrator of the Web system inactivates the Web server in order to update the library to the lib v2 from the lib v1. After inactivating the Web server, the administrator inactivates the lib v1, and uninstalls the lib v1 from the OS. After the uninstallation, the administrator installs the lib v2 onto the OS.

Then, the administrator of the Web system again activates the Web server. After the activation, the administrator installs the Ap v2 onto the Web server. By execution of the work described above, the Ap v2 is substituted for the AP v1 in the Web system illustrated in (a) in FIG. 12.

A configuration alteration of a system in which a state of a component is altered is represented by a directed graph being a graph composed of a vertex and an edge having a direction. FIG. 13 is an explanatory diagram illustrating an example of a directed graph representing a configuration alteration of a system. Hereinafter, the directed graph as illustrated in FIG. 13 is also referred to as a state graph.

The vertex of the state graph illustrated in FIG. 13 represents a state of the system. The vertex of the state graph illustrated in FIG. 13 is constituted by a state of each component constituting the system. Specifically, a left vertex illustrated in FIG. 13 is constituted by respective states “active” of the AP v1, “unloaded” of the AP v2, “active” of the Web server, “active” of the lib v1, and “unloaded” of the lib v2. Moreover, a right vertex illustrated in FIG. 13 is constituted by respective states “active” of the AP v1, “unloaded” of the AP v2, “inactive” of the Web server, “active” of the lib v1, and “unloaded” of the lib v2.

Furthermore, the edge of the state graph illustrated in FIG. 13 represents a configuration alteration of the system. Specifically, an edge directed to the right vertex from the left vertex illustrated in FIG. 13 represents a configuration alteration of the system in which a state of the Web server is altered from “active” to “inactive”.

Forming a work procedure of altering the current configuration of the ICT system to a required configuration is equivalent to detecting a path with a start point given by a vertex representing the current state of the ICT system in the directed graph, and an end point given by a vertex representing a required state of the ICT system. In light of a fact that a length of the path corresponds to an amount of the work procedure, a path to be detected is preferably a shortest path among path candidates.

Therefore, when a definition of a configuration alteration of a system is represented by a directed graph, a problem of forming a work procedure of a configuration alteration is a problem of discovering a shortest path linking a start point representing a state before alteration in the directed graph and an end point representing a state after alteration.

Examples of a method of discovering a shortest path in a directed graph includes Dijkstra's algorithm described in NPL 1, and A* search algorithm described in NPL 2 being Dijkstra's algorithm in which search processing is accelerated. Dijkstra's algorithm is considered to be one example embodiment of A* search algorithm, and A* search algorithm is therefore described below.

FIG. 14 is a block diagram illustrating a configuration example of a general system configuration alteration procedure generation device 100. The system configuration alteration procedure generation device 100 is a device which discovers a shortest path by use of A* search algorithm.

The system configuration alteration procedure generation device 100 includes an adjacent vertex acquisition unit 101, an estimate arrival distance computation unit 102, a shortest distance vertex selection unit 103, an under-retrieval vertex table storage unit 104, a retrieved vertex table storage unit 105, a path tree information storage unit 106, and a shortest path acquisition unit 107.

The adjacent vertex acquisition unit 101 has a function of obtaining a directed graph (state graph) as an input, and acquiring an adjacent vertex being a next vertex adjacent to an input vertex. The adjacent vertex is a vertex which is linked to a specified vertex in the state graph by an edge. The adjacent vertex acquisition unit 101 inputs the acquired adjacent vertex to the estimate arrival distance computation unit 102 and the shortest distance vertex selection unit 103.

The estimate arrival distance computation unit 102 has a function of obtaining, as an input, the adjacent vertex output by the adjacent vertex acquisition unit 101, and an end vertex representing a system configuration being an alteration target, and calculating an estimate arrival distance being a distance in the state graph from the adjacent vertex to the end vertex. The estimate arrival distance computation unit 102 calculates an estimate arrival distance, for example, by projecting the number of weighted hops in the state graph. The estimate arrival distance computation unit 102 inputs the calculated estimate arrival distance to the shortest distance vertex selection unit 103.

The estimate arrival distance computation unit 102 is considered to be a function of calculating an estimate arrival distance up to an end vertex, and is therefore called a heuristic function. Moreover, it is known that, when an estimate arrival distance is constantly less than or equal to a distance (arrival distance) up to an end vertex, a shortest path is certainly discovered by A* search algorithm as long as a path from a start vertex to the end vertex exists. An estimate arrival distance which is constantly less than or equal to a distance up to an end vertex is called an admissible estimate arrival distance.

The shortest distance vertex selection unit 103 has a function of obtaining, as an input, the adjacent vertex output by the adjacent vertex acquisition unit 101, and the estimate arrival distance related to the adjacent vertex and output by the estimate arrival distance computation unit 102, and selecting a next vertex to be retrieved, from out of adjacent vertexes.

The under-retrieval vertex table storage unit 104 has a function of storing an under-retrieval vertex table on which a vertex under retrieval is registered among vertexes in the state graph. Moreover, the retrieved vertex table storage unit 105 has a function of storing a retrieved vertex table on which a retrieved vertex is registered among vertexes in the state graph.

FIG. 15 is an explanatory diagram illustrating an example of an under-retrieval vertex table. Note that a format of a retrieved vertex table is also similar to a format in the example illustrated in FIG. 15.

On the under-retrieval vertex table illustrated in FIG. 15, computation results of an estimate arrival distance and a determinate distance regarding a vertex under retrieval are registered. For example, FIG. 15 illustrates that an estimate arrival distance regarding a vertex v₂ is 2, and a determinate distance thereof is 7.

The path tree information storage unit 106 has a function of storing path tree information being information on a path constituted by a vertex under retrieval and a retrieved vertex. The path tree information is stored in a tree data structure in which a start vertex is a root. In other words, tree type data are stored in the path tree information storage unit 106.

The shortest distance vertex selection unit 103 selects a next vertex to be retrieved, referring to the under-retrieval vertex table stored in the under-retrieval vertex table storage unit 104, the retrieved vertex table stored in the retrieved vertex table storage unit 105, and the path tree information stored in the path tree information storage unit 106.

The shortest distance vertex selection unit 103 first extracts adjacent vertexes of a vertex registered on the under-retrieval vertex table. Then, the shortest distance vertex selection unit 103 selects, as a next vertex to be retrieved, a vertex in which an estimate arrival distance being an anticipated distance up to an end vertex computed by the estimate arrival distance computation unit 102 is the shortest among the extracted adjacent vertexes.

The search algorithm by the shortest distance vertex selection unit 103 as described above is called best-first search algorithm. When precision of an anticipated distance (estimate arrival distance) calculated by the estimate arrival distance computation unit 102 is high, the shortest distance vertex selection unit 103 can search for a next vertex to be retrieved, at a high speed. Note that, after selecting a next vertex to be retrieved, the shortest distance vertex selection unit 103 updates the under-retrieval vertex table, the retrieved vertex table, and the path tree information, respectively.

The shortest path acquisition unit 107 has a function of acquiring a shortest path in the state graph on the basis of the path tree information stored in the path tree information storage unit 106, after an end vertex is retrieved.

An example in which the shortest path acquisition unit 107 acquires a shortest path in the state graph on the basis of the path tree information is illustrated in FIG. 16. FIG. 16 is an explanatory diagram illustrating an example of the path tree information stored in the path tree information storage unit 106.

In a path tree illustrated in FIG. 16, a start vertex is v₀, and an end vertex is vₑ. The path tree illustrated in FIG. 16 is constituted by three paths “v₀→v₂→v₅”, “v₀→v₁→v₄”, and “v₀→v₁→v₃→vₑ”. In addition, a broken-line arrow illustrated in FIG. 16 represents a shortest distance.

When vₑ being the end vertex is retrieved, vₑ being the end vertex is input to the shortest path acquisition unit 107. In the case of the example illustrated in FIG. 16, the shortest path acquisition unit 107 acquires “v₀→v₁→v₃→vₑ” as a shortest path.

An operation of the general system configuration alteration procedure generation device 100 is described below with reference to FIG. 17. FIG. 17 is a flowchart illustrating an overall operation of alteration procedure generation processing by the general system configuration alteration procedure generation device 100.

First, the shortest distance vertex selection unit 103 obtains an estimate arrival distance regarding a start vertex representing an initial state of the system, from the estimate arrival distance computation unit 102 (step S1000). Then, the shortest distance vertex selection unit 103 registers the start vertex being a start point on the under-retrieval vertex table, together with the obtained estimate arrival distance, and a determinate distance 0 being a distance from the start vertex (step S1010). In other words, the system configuration alteration procedure generation device 100 enters a vertex retrieval loop (step S1020).

Then, the shortest distance vertex selection unit 103 extracts a shortest distance vertex e in which a sum of an estimate arrival distance and a determinate distance registered together is the shortest, among vertexes registered on the under-retrieval vertex table (step S1030). Then, the shortest distance vertex selection unit 103 ascertains whether or not the extracted shortest distance vertex e is included in a set of end vertexes (step S1040).

When the shortest distance vertex e is included in the set of end vertexes (Yes in step S1040), the system configuration alteration procedure generation device 100 escapes from the vertex retrieval loop, and advances the processing to step S1080.

When the shortest distance vertex e is not included in the set of end vertexes (No in step S 1040), the shortest distance vertex selection unit 103 deletes the extracted shortest distance vertex e from the under-retrieval vertex table, and registers the extracted shortest distance vertex e on the retrieved vertex table (step S1050).

Then, the shortest distance vertex selection unit 103 obtains a set of adjacent vertexes regarding the shortest distance vertex e from the adjacent vertex acquisition unit 101 (step S1060). In other words, the system configuration alteration procedure generation device 100 enters an adjacent vertex processing loop (step S1070).

First, the shortest distance vertex selection unit 103 extracts an unprocessed adjacent vertex f from the obtained set of adjacent vertexes regarding the shortest distance vertex e. Regarding the extracted adjacent vertex f, the shortest distance vertex selection unit 103 computes a temporary determinate distance d_{f}′ being a distance in the state graph from the start vertex to the adjacent vertex f. The shortest distance vertex selection unit 103 sets, to d_{f}′, Dₑ which is a sum of a determinate distance dₑ of the shortest distance vertex e extracted from the under-retrieval vertex table, and a distance d(e, f) between the adjacent vertex f and the shortest distance vertex e (step S1080).

Then, the estimate arrival distance computation unit 102 computes a temporary estimate arrival distance h_{f}′ regarding the adjacent vertex f (step S1090). After the temporary estimate arrival distance h_{f}′ is computed, the shortest distance vertex selection unit 103 ascertains whether or not the adjacent vertex f is registered on the under-retrieval vertex table or the retrieved vertex table (step S1100).

When the adjacent vertex f is not registered on either the under-retrieval vertex table or the retrieved vertex table (a condition [not exist in either under-retrieval vertex table or retrieved vertex table] in step S1100), the adjacent vertex f is a vertex that is not yet retrieved. When the adjacent vertex f is a vertex that is not yet retrieved, the shortest distance vertex selection unit 103 advances the processing to step S1120.

When the adjacent vertex f is registered on the under-retrieval vertex table (a condition [exist in under-retrieval vertex table] in step S 1100), the shortest distance vertex selection unit 103 advances the processing to step S1130. When the adjacent vertex f is registered on the retrieved vertex table (a condition [exist in retrieved vertex table] in step S 1100), the shortest distance vertex selection unit 103 advances the processing to step S1140.

Note that, in the present example, the same vertex is not simultaneously registered on the under-retrieval vertex table and the retrieved vertex table.

While an unprocessed adjacent vertex exists among the set of adjacent vertexes regarding the shortest distance vertex e, the system configuration alteration procedure generation device 100 repeatedly executes the processing in steps S1080 to S1140. The processing in steps S1080 to S1140 is repeatedly executed for each adjacent vertex regarding the shortest distance vertex e as many times as the number of adjacent vertexes.

When all of the adjacent vertexes regarding the shortest distance vertex e have been processed, the system configuration alteration procedure generation device 100 escapes from the adjacent vertex processing loop (step S1150).

While a vertex is registered on the under-retrieval vertex table, the system configuration alteration procedure generation device 100 repeatedly executes the processing in steps S1030 to S1150. The processing in steps S1030 to S1150 is repeatedly executed for each vertex registered on the under-retrieval vertex table, as many times as the number of vertexes to be registered.

Note that, in the repetitive processing in steps S1030 to S1150 in the present example, the processing does not proceed to step S1180 unless a condition in step S1040 that the shortest distance vertex e be included in the set of end vertexes is satisfied, i.e., unless an end vertex representing a system configuration being an alteration target is retrieved.

When no vertex is registered on the under-retrieval vertex table, and the processing does not proceed to step S1180, the shortest path acquisition unit 107 escapes from the vertex retrieval loop, and determines that a path linking the start vertex and the end vertex does not exist (step S1170). After the determination, the system configuration alteration procedure generation device 100 ends the alteration procedure generation processing.

When the shortest distance vertex e is included in the set of end vertexes (Yes in step S1040), there exists a shortest path in the state graph from a start vertex representing the current system configuration to an end vertex representing a system configuration being an alteration target. The shortest path acquisition unit 107 extracts the shortest distance vertex e included in the set of end vertexes.

Then, the shortest path acquisition unit 107 acquires a shortest path by tracing a path tree indicated by path tree information from the shortest distance vertex e (step S1180). After the acquisition, the system configuration alteration procedure generation device 100 ends the alteration procedure generation processing.

Sub-processing constituting the alteration procedure generation processing is described below. First, under-retrieval vertex table registration processing in step S1120 is described. FIG. 18 is a flowchart illustrating an operation of the under-retrieval vertex table registration processing by the shortest distance vertex selection unit 103.

The shortest distance vertex selection unit 103 registers, on the under-retrieval vertex table, the adjacent vertex f, the temporary determinate distance d_{f}′ of the adjacent vertex f calculated in step S1080, and the temporary estimate arrival distance h_{f}′ calculated in step S1090 (step S1121). After the registration, the shortest distance vertex selection unit 103 advances the processing to step S1150.

Next, parent vertex replacement processing in step S1130 is described. FIG. 19 is a flowchart illustrating an operation of the parent vertex replacement processing by the shortest distance vertex selection unit 103.

The shortest distance vertex selection unit 103 acquires a sum D_{f} of a determinate distance d_{f} and an estimate arrival distance h_{f} of the adjacent vertex f registered on the under-retrieval vertex table. Similarly, the shortest distance vertex selection unit 103 acquires a sum D_{f}′ of the temporary determinate distance d_{f}′ of the adjacent vertex f calculated in step S1080 and the temporary estimate arrival distance h_{f}′ calculated in step S1090. Then, the shortest distance vertex selection unit 103 compares D_{f} with D_{f}′ (step S1131).

When D_{f} of the adjacent vertex f is longer than D_{f}′ (Yes in step S 1132), the shortest distance vertex selection unit 103 replaces the determinate distance d_{f} of the adjacent vertex f registered on the under-retrieval vertex table with the temporary determinate distance d_{f}′, and the estimate arrival distance h_{f} of the adjacent vertex f with the temporary estimate arrival distance h_{f}′, respectively (step S1133). After the replacement, the shortest distance vertex selection unit 103 advances the processing to step S1150.

When D_{f} of the adjacent vertex f is less than or equal to D_{f}′ (No in step S1132), the shortest distance vertex selection unit 103 keeps the determinate distance d_{f} and the estimate arrival distance h_{f} of the adjacent vertex f being registered on the under-retrieval vertex table, and advances the processing to step S1150.

Next, retrieved vertex table transfer processing in step S1140 is described. FIG. 20 is a flowchart illustrating an operation of the retrieved vertex table transfer processing by the shortest distance vertex selection unit 103.

The shortest distance vertex selection unit 103 computes a sum D_{f} of a determinate distance d_{f} and an estimate arrival distance h_{f} of the adjacent vertex f registered on the retrieved vertex table. Similarly, the shortest distance vertex selection unit 103 computes a sum D_{f}′ of the temporary determinate distance d_{f}′ of the adjacent vertex f calculated in step S1080 and the temporary estimate arrival distance h_{f}′ calculated in step S1090. Then, the shortest distance vertex selection unit 103 compares D_{f} with D_{f}′ (step S1141).

When D_{f} of the adjacent vertex f is longer than D_{f}′ (Yes in step S1142), the shortest distance vertex selection unit 103 transfers the adjacent vertex f registered on the retrieved vertex table to the under-retrieval vertex table (step S1143). By the transfer of the adjacent vertex f to the under-retrieval vertex table, an adjacent vertex regarding the adjacent vertex f is retrieved.

Then, the shortest distance vertex selection unit 103 replaces the determinate distance d_{f} of the adjacent vertex f registered on the under-retrieval vertex table with the temporary determinate distance d_{f}′, and the estimate arrival distance h_{f} of the adjacent vertex f with the temporary estimate arrival distance h_{f}′, respectively (step S1144).

Then, the shortest distance vertex selection unit 103 exchanges a parent vertex of the adjacent vertex f indicated by path tree information for the shortest distance vertex e (step S1145). After the exchange, the shortest distance vertex selection unit 103 advances the processing to step S1150.

When D_{f} of the adjacent vertex f is less than or equal to D_{f}′ (No in step S1142), the shortest distance vertex selection unit 103 keeps the determinate distance d_{f} and the estimate arrival distance h_{f} of the adjacent vertex f being registered on the retrieved vertex table, and advances the processing to step S1150.

The above-described operation of each piece of processing illustrated in FIGS. 17 to 20 is known as an operation based on A* search algorithm described in NPL 2.

### CITATION LIST

### Patent Literature

[PTL 1] Japanese Unexamined Patent Application Publication (Translation of PCT Application) No. 2014-506409

[PTL 2] Japanese Unexamined Patent Application Publication No. H04-47356

### Non Patent Literature

[NPL 1] “Dijkstra's algorithm”, [online], Wikipedia, [retrieved on January 29, 2016], Internet <https://ja.wikipedia.org/wiki/%E3%83%80%E3%82%A4%E3%82% AF%E3%82%B9%E3%83%88%E3%83%A9%E6%B3%95>

[NPL 2] “A*”, [online], Wikipedia, [retrieved on Jan. 29, 2016], Internet <https://ja.wikipedia.org/wiki/A*>

### SUMMARY OF INVENTION

### Technical Problem

Alteration procedure generation processing using A* search algorithm has a problem that a method of computing an estimate arrival distance being appropriate for generating an alteration procedure of an ICT system configuration is not obvious. Generally, in A* search algorithm, when a method of computing an estimate arrival distance is appropriately determined in accordance with a problem to be solved, search efficiency improves. However, a method of computing an estimate arrival distance being appropriate for each problem is not obvious.

Furthermore, as in the example described above, a configuration alteration of an ICT system requires updating of versions of other modules for updating of a version of a Web application, or requires temporal alterations of states of other modules for updating of a version of a module.

In other words, it is required that an alteration procedure of an ICT system configuration is generated in consideration of a complex dependence relationship. In A* search algorithm of solving a problem of generation of an alteration procedure of an ICT system configuration, an appropriate method of computing an estimate arrival distance in which a search is efficiently performed is not obvious.

Moreover, because discovery of a shortest path is an ultimate goal in the problem of generation of an alteration procedure of an ICT system configuration, an appropriate method of computing an estimate arrival distance is required to be an admissible computation method. In addition, time for computation of an estimate arrival distance is preferably as short as possible.

Thus, the present invention is intended to provide an alteration procedure generation system, an alteration procedure generation method, and an alteration procedure generation program, being capable of appropriately generating an alteration procedure of a system in which a dependence relationship exists between attributes constituting the system.

### Solution to Problem

An alteration procedure generation system according to the present invention includes:

computation means for computing an estimate arrival distance by

adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and

subtracting the predetermined value from the sum total.

An alteration procedure generation method according to the present invention includes:

computing an estimate arrival distance by

adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and

subtracting the predetermined value from the sum total.

An alteration procedure generation program according to the present invention causing a computer to execute:

a computation process of computing an estimate arrival distance by

adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and

subtracting the predetermined value from the sum total.

### Advantageous Effects of Invention

According to the present invention, it is possible to appropriately generating an alteration procedure of a system in which a dependence relationship exists between attributes constituting the system.

### BRIEF DESCRIPTION OF DRAWINGS

FIG. 1 is a block diagram illustrating a configuration example of a first example embodiment of a system configuration alteration procedure generation system 10 according to the present invention.

FIG. 2 is a flowchart illustrating an overall operation of alteration procedure generation processing by a system configuration alteration procedure generation device 100 according to the present example embodiment.

FIG. 3 is a flowchart illustrating an operation of estimate arrival distance computation processing by an estimate arrival distance computation unit 109.

FIG. 4 is an explanatory diagram illustrating a dependence relationship existing between components constituting a Web system illustrated in FIG. 12.

FIG. 5 is an explanatory diagram illustrating an example of a directed graph representing a definition of a configuration alteration of a system.

FIG. 6 is an explanatory diagram illustrating an example of a shortest path linking a start vertex and an end vertex illustrated in FIG. 5.

FIG. 7 is an explanatory diagram illustrating an example of search processing of a shortest path illustrated in FIG. 6.

FIG. 8 is an explanatory diagram illustrating another example of search processing of a shortest path illustrated in FIG. 6.

FIG. 9 is an explanatory diagram illustrating an evaluation result of search processing of a shortest path executed on the basis of each scheme.

FIG. 10 is a block diagram illustrating an overview of an alteration procedure generation system according to the present invention.

FIG. 11 is a block diagram illustrating a configuration example of a general system configuration alteration device.

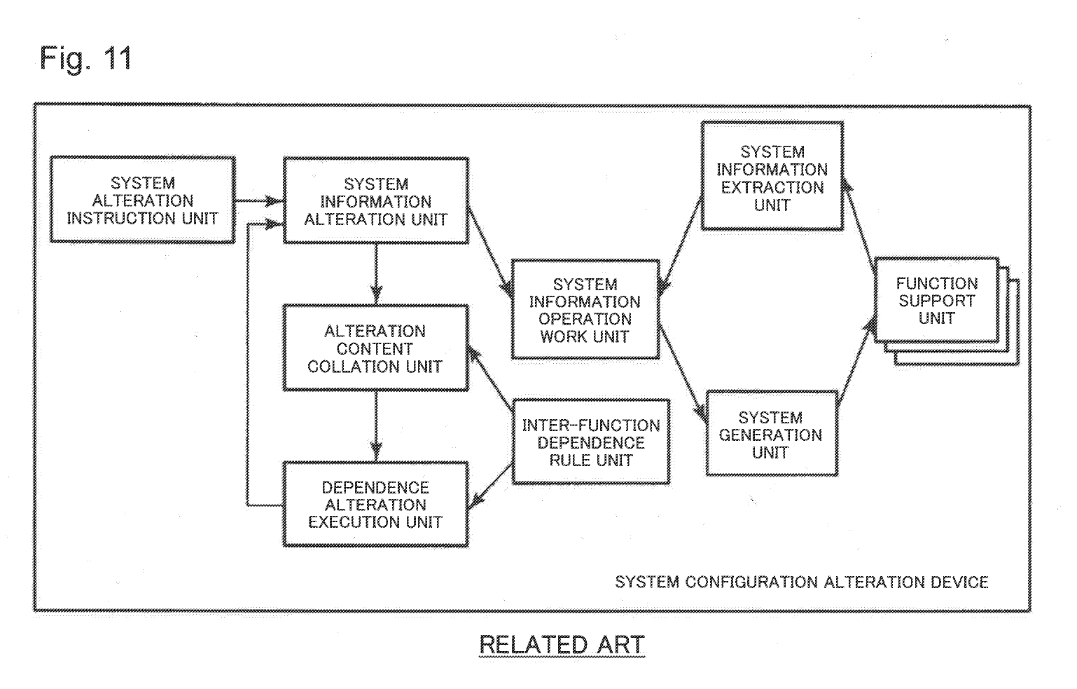

FIG. 12 is an explanatory diagram illustrating an example of a dependence relationship in a Web system.

FIG. 13 is an explanatory diagram illustrating an example of a directed graph representing a configuration alteration of a system.

FIG. 14 is a block diagram illustrating a configuration example of a general system configuration alteration procedure generation device 100.

FIG. 15 is an explanatory diagram illustrating an example of an under-retrieval vertex table.

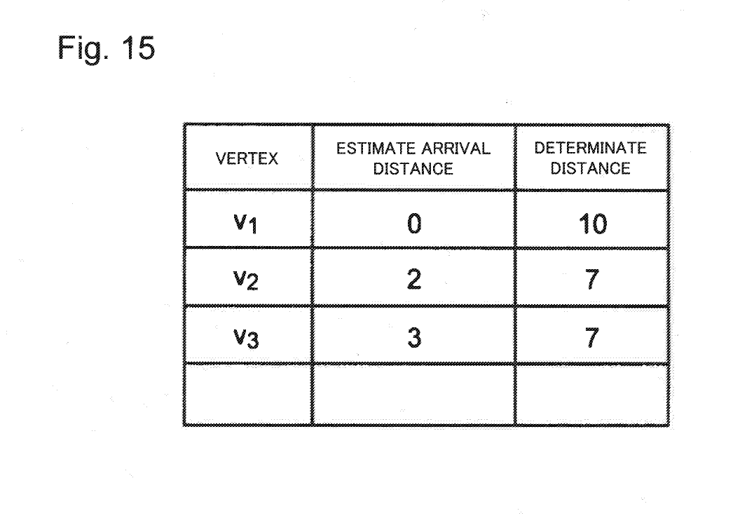

FIG. 16 is an explanatory diagram illustrating an example of the path tree information stored in a path tree information storage unit 106.

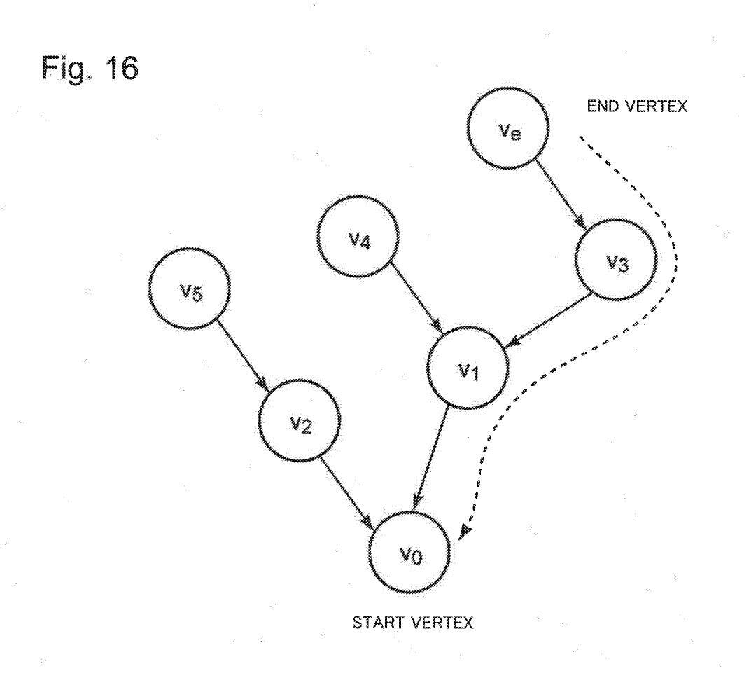

FIG. 17 is a flowchart illustrating an overall operation of alteration procedure generation processing by the general system configuration alteration procedure generation device 100.

FIG. 18 is a flowchart illustrating an operation of under-retrieval vertex table registration processing by a shortest distance vertex selection unit 103.

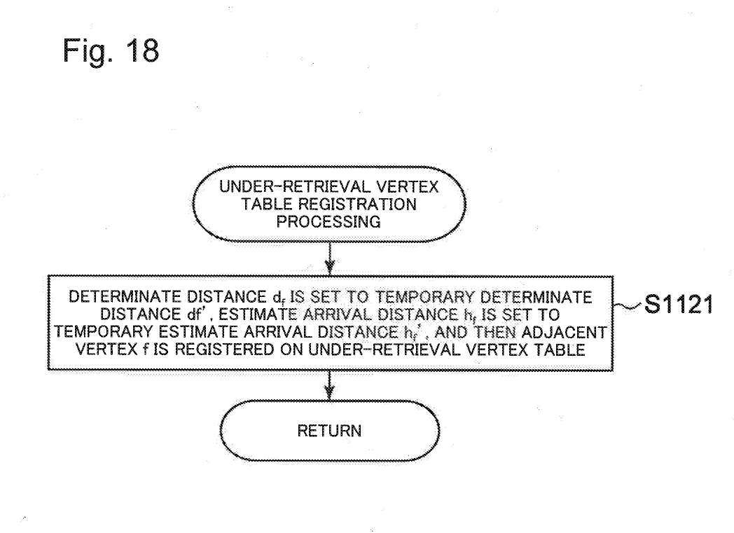

FIG. 19 is a flowchart illustrating an operation of parent vertex replacement processing by the shortest distance vertex selection unit 103.

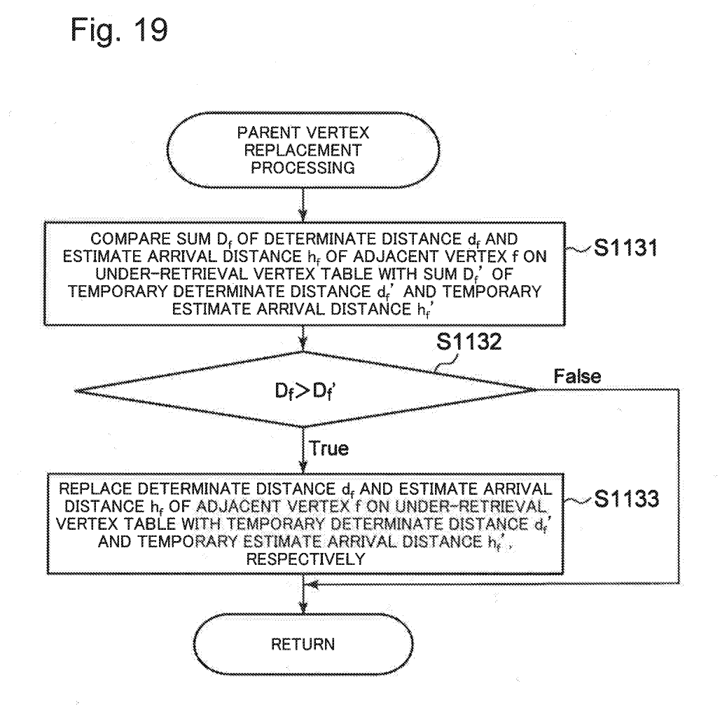

FIG. 20 is a flowchart illustrating an operation of retrieved vertex table transfer processing by the shortest distance vertex selection unit 103.

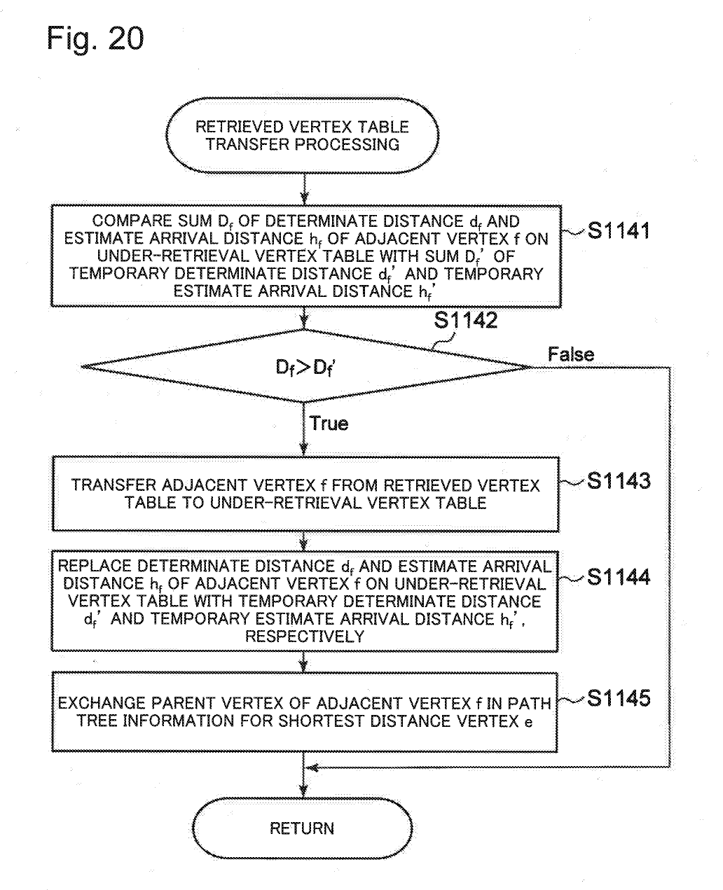

### DESCRIPTION OF EMBODIMENTS

### Example Embodiment 1

### Description of Configuration

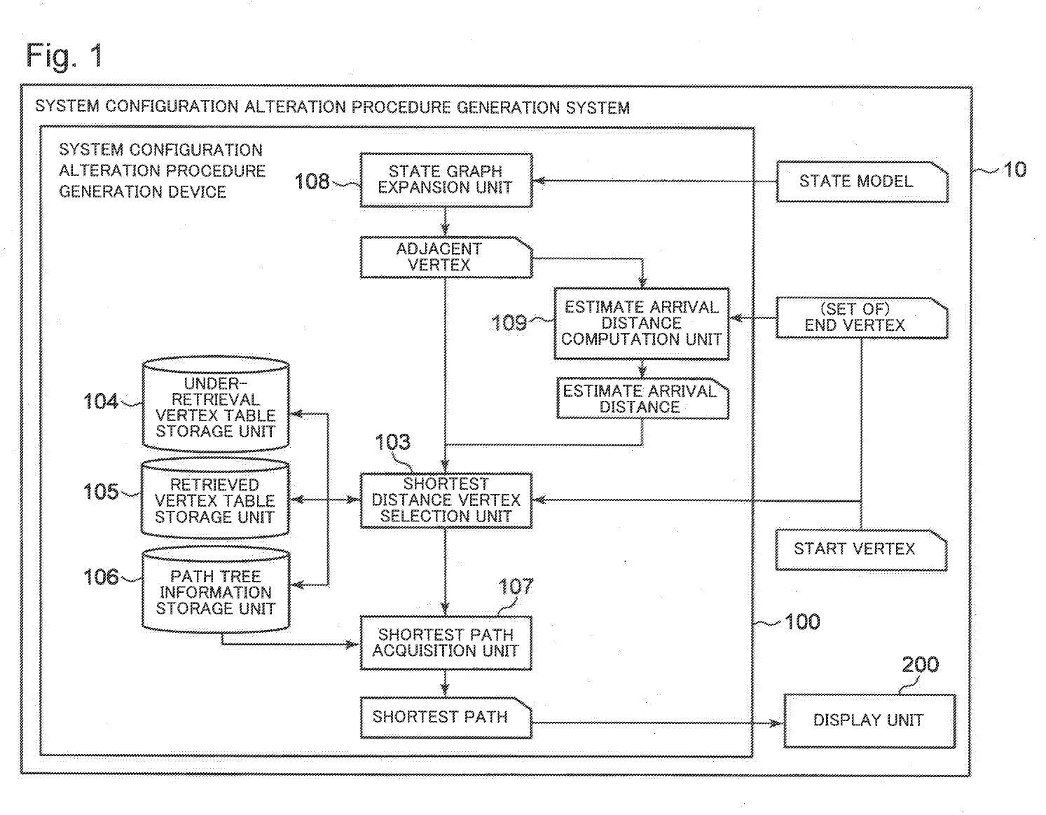

Hereinafter, example embodiments of the present invention will be described with reference to the drawings. FIG. 1 is a block diagram illustrating a configuration example of a first example embodiment of a system configuration alteration procedure generation system 10 according to the present invention.

As illustrated in FIG. 1, the system configuration alteration procedure generation system 10 according to the present example embodiment includes a system configuration alteration procedure generation device 100, and a display unit 200. Note that the system configuration alteration procedure generation system 10 does not need to include the display unit 200. In addition, the system configuration alteration procedure generation device 100 is a singly usable device.

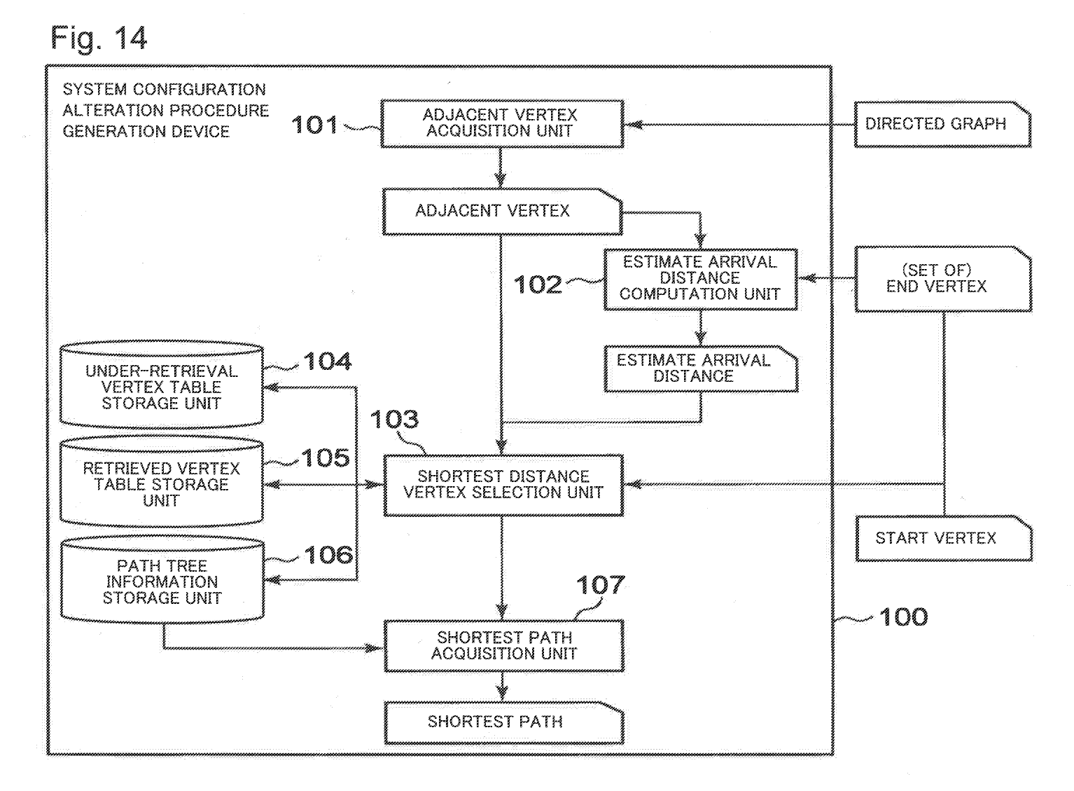

The system configuration alteration procedure generation device 100 illustrated in FIG. 1 includes a state graph expansion unit 108, an estimate arrival distance computation unit 109, a shortest distance vertex selection unit 103, an under-retrieval vertex table storage unit 104, a retrieved vertex table storage unit 105, a path tree information storage unit 106, and a shortest path acquisition unit 107. The configuration of the system configuration alteration procedure generation device 100 illustrated in FIG. 1 except for the state graph expansion unit 108 and the estimate arrival distance computation unit 109 is similar to the configuration of a system configuration alteration procedure generation device 100 illustrated in FIG. 14.

The state graph expansion unit 108 has a function of obtaining, as a state model, information regarding a system configuration and a configuration alteration, and acquiring an adjacent vertex which is a next vertex adjacent to an input vertex.

The estimate arrival distance computation unit 109 has a function of obtaining, as an input, the adjacent vertex output by the state graph expansion unit 108, and an end vertex representing a system configuration to which to be altered, and calculating an estimate arrival distance which is a distance in a state graph from the adjacent vertex to the end vertex. Computation performance of the estimate arrival distance computation unit 109 according to the present example embodiment depends on a state graph targeted for computation, in contract to an estimate arrival distance computation unit 102 illustrated in FIG. 14.

In the present example embodiment, the estimate arrival distance computation unit 109 uses, for computation of an estimate arrival distance, a penalty p representing a relationship in which when a value of an attribute is altered, values of other attributes are also altered, i.e., a dependence relationship existing between components (attributes).

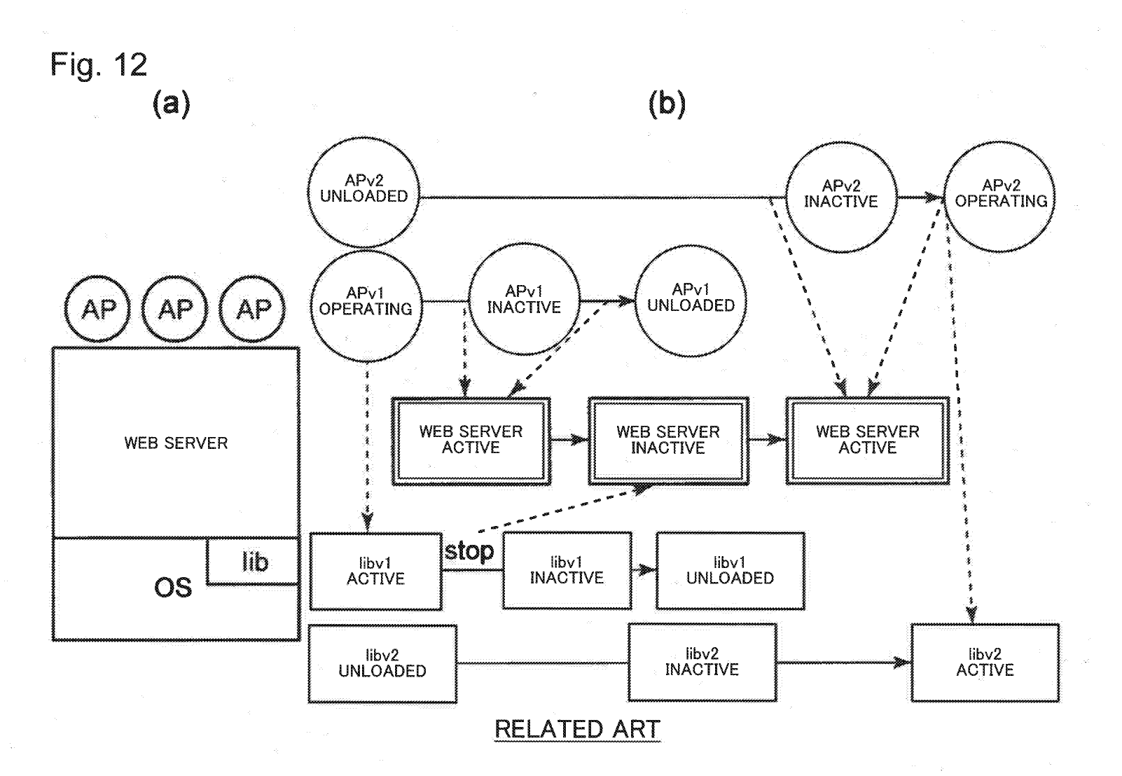

For example, as illustrated in (b) in FIG. 12, when a state of an attribute “Web server” of a Web system is “active”, a state of an attribute “lib v1” of the Web system is not altered from “active” to “unloaded”. In other words, a dependence relationship exists between the attribute “Web server” and the attribute “lib v1”.

Otherwise, when the state of the attribute “Web server” is already “inactive”, the state of the attribute “lib v1” is altered from “active” to “unloaded”. In other words, a dependence relationship does not exist between the attribute “Web server” and the attribute “lib v1”.

The penalty p is a nonnegative integer. Moreover, it is assumed that a maximum value of the penalty p according to the present example embodiment is pₘₐₓ. In other words, the penalty p is certain to be less than or equal to pₘₐₓ.

Each unit of the system configuration alteration procedure generation device 100 models a system configuration represented by a state model and contents of an update request in a state graph. Moreover, as in the system configuration alteration procedure generation device 100 illustrated in FIG. 14, the shortest path acquisition unit 107 finds a shortest path linking a start vertex and an end vertex, thereby generating a configuration alteration procedure for altering the current system configuration represented by the start vertex to a targeted system configuration represented by the end vertex. When a configuration alteration procedure is generated, the estimate arrival distance computation unit 109 appropriately projects a graph distance, thereby searching for a vertex at a high speed.

The display unit 200 has a function of displaying the shortest path linking the start vertex and the end vertex acquired by the shortest path acquisition unit 107. The display unit 200 is a display device such as a liquid crystal display device, for example.

### Description of Operation

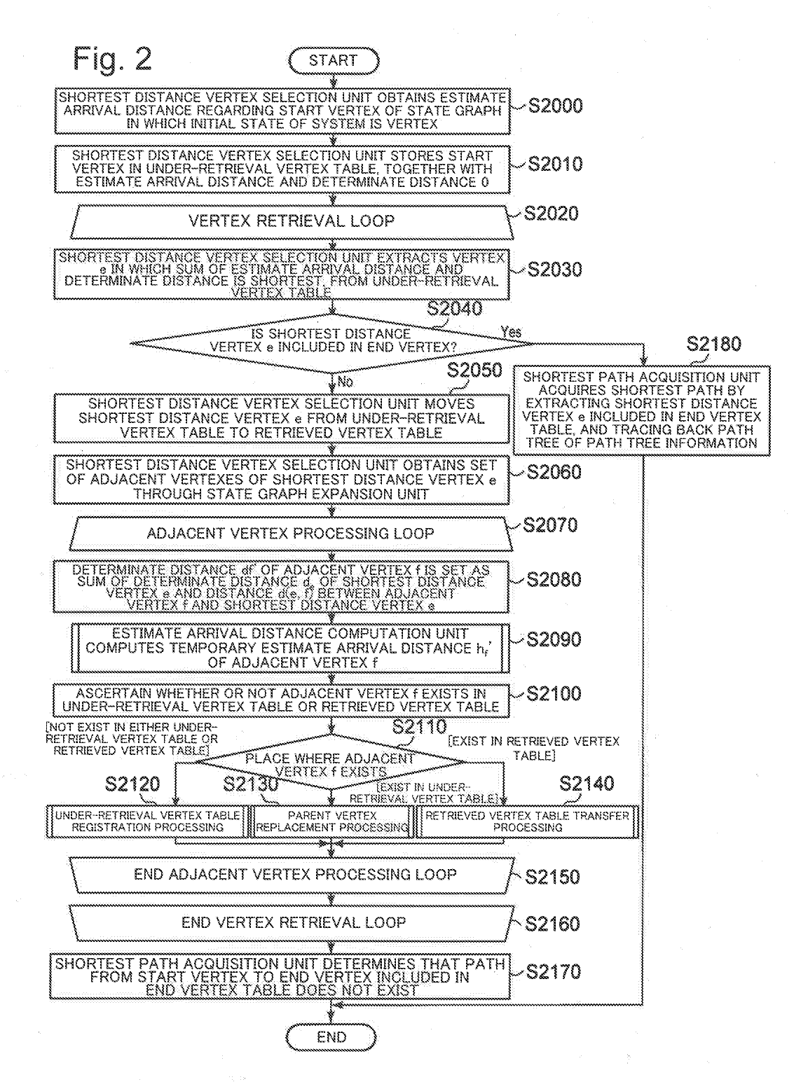

An operation of the system configuration alteration procedure generation device 100 according to the present example embodiment is described below with reference to FIG. 2. FIG. 2 is a flowchart illustrating an overall operation of alteration procedure generation processing by the system configuration alteration procedure generation device 100 according to the present example embodiment.

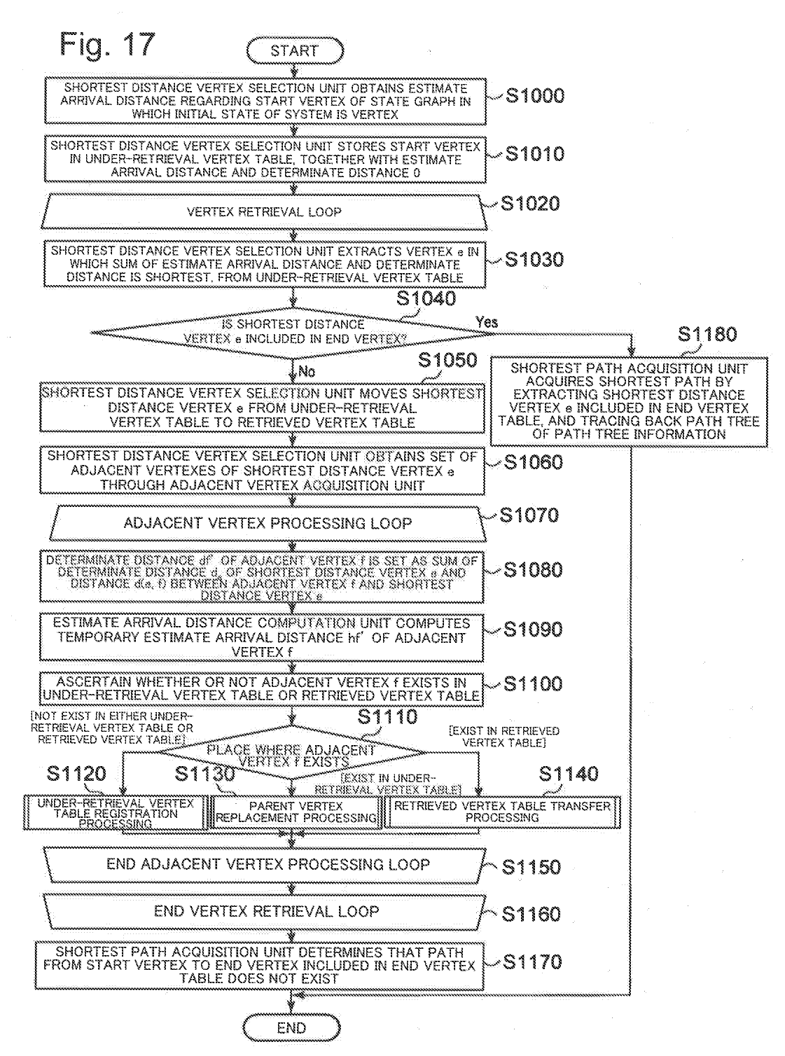

Processing in steps S2000 to S2050 is similar to processing in steps S1000 to S1150 illustrated in FIG. 17.

The shortest distance vertex selection unit 103 obtains a set of adjacent vertexes regarding a shortest distance vertex e from the state graph expansion unit 108 (step S2060). In other words, the system configuration alteration procedure generation device 100 enters an adjacent vertex processing loop (step S2070).

Processing in steps S2080 to S2180 is similar to processing in steps S1080 to S1180 illustrated in FIG. 17.

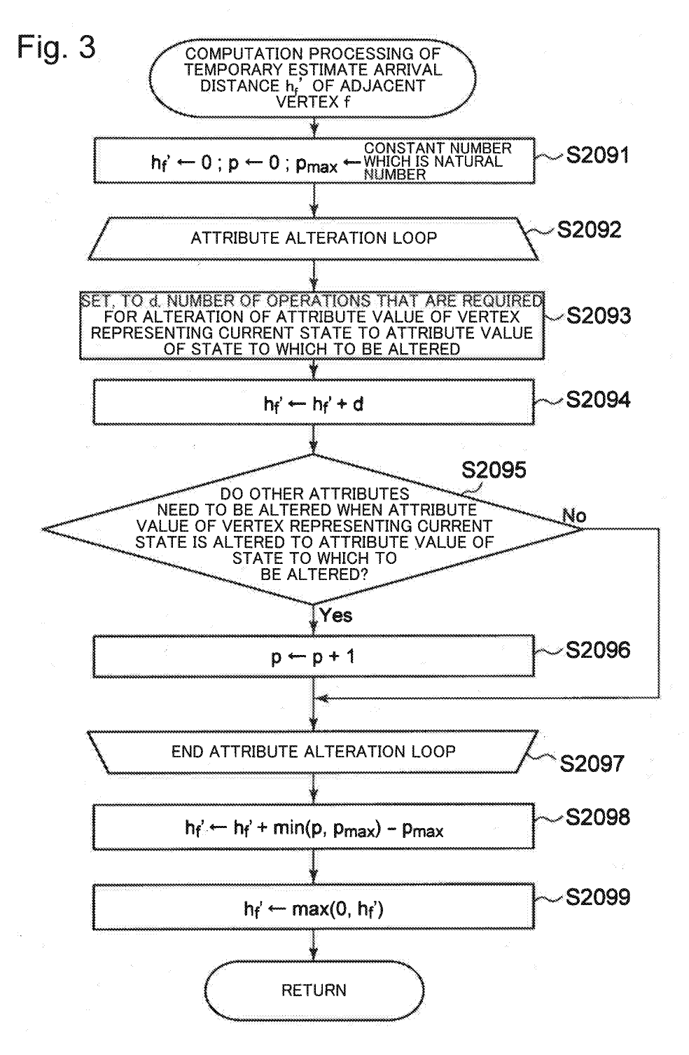

Estimate arrival distance computation processing in step S2090 which is original processing according to the present example embodiment in the sub-processing constituting the alteration procedure generation processing is described below. FIG. 3 is a flowchart illustrating an operation of the estimate arrival distance computation processing by the estimate arrival distance computation unit 109.

First, the estimate arrival distance computation unit 109 initializes, to 0, a temporary estimate arrival distance h_{f}′ regarding an adjacent vertex f, and a penalty p, respectively. The estimate arrival distance computation unit 109 also initializes pₘₐₓ to a constant number which is a natural number (step S2091). In other words, the estimate arrival distance computation unit 109 enters an attribute alteration loop (step S2092).

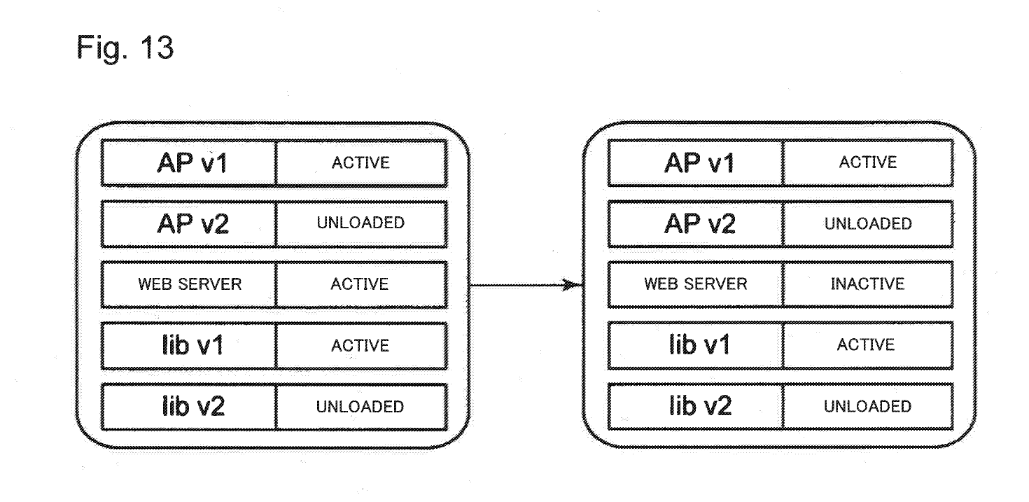

As illustrated in FIG. 13, the adjacent vertex f representing a system configuration in a predetermined state includes a plurality of attributes. The estimate arrival distance computation unit 109 extracts an unprocessed attribute a from the attributes included in the adjacent vertex f. Then, the estimate arrival distance computation unit 109 calculates a number of operations d that are required for alteration of an attribute value v of the extracted attribute a of the adjacent vertex f to an attribute value v′ of the attribute a included in a vertex g representing a system configuration to which to be altered (step S2093).

Then, the estimate arrival distance computation unit 109 adds the calculated number of operations d to the temporary estimate arrival distance h_{f}′ (step S2094). In step S2094, no consideration is given to a dependence relationship existing between components (i.e., attributes) constituting a system the configuration of which is to be altered.

Then, the estimate arrival distance computation unit 109 ascertains whether or not a dependence relationship exists between attributes in the alteration of the attribute value regarding the number of operations d calculated in step S2093 (step S2095).

When a dependence relationship exists between attributes (Yes in step S2095), the estimate arrival distance computation unit 109 adds 1 to the penalty p (step S2096). After the addition, the estimate arrival distance computation unit 109 advances the processing to step S2097.

When a dependence relationship does not exist between attributes (No in step S2095), the estimate arrival distance computation unit 109 advances the processing to step S2097 without updating the penalty p.

While an unprocessed attribute exists among the attributes included in the adjacent vertex f, the estimate arrival distance computation unit 109 repeatedly executes the processing in steps S2093 to S2096. The processing in steps S2093 to S2096 is repeatedly executed for each attribute included in the adjacent vertex f as many times as the number of included attributes. When all of the attributes included in the adjacent vertex f have been processed, the estimate arrival distance computation unit 109 escapes from the attribute alteration loop (step S2097).

After escaping from the attribute alteration loop, the estimate arrival distance computation unit 109 reflects the penalty p in the temporary estimate arrival distance h_{f}′ as indicated in Expression (1) below (step S2098).

h_{f}′←h_{f}′+min(p, pₘₐₓ)−pₘₐₓ Expression (1)

Note that min (p, pₘₐₓ) in Expression (1) is a function which returns a lower value between p and pₘₐₓ. After computing h_{f}′ in accordance with Expression (1), the estimate arrival distance computation unit 109 determines a return value of the temporary estimate arrival distance h_{f}′ as indicated in Expression (2) below (step S2099).

h_{f}′←max(0, h_{f}′) Expression (2)

Note that max(0, h_{f}′) in Expression (2) is a function which returns a higher value between 0 and h_{f}′. In other words, when the calculated h_{f}′ is negative, 0 becomes a return value of the temporary estimate arrival distance found in the sub-processing. Otherwise, when the calculated h_{f}′ is positive, h_{f}′ becomes a return value of the temporary estimate arrival distance found in the sub-processing. After determining a return value of the temporary estimate arrival distance, the estimate arrival distance computation unit 109 ends the estimate arrival distance computation processing.

Note that an estimate arrival distance is required to be an admissible estimate arrival distance. In other words, a distance to arrive at an end vertex is required to be less than or equal to the estimate arrival distance. The following indicates that the estimate arrival distance found in the above-described estimate arrival distance computation processing by the estimate arrival distance computation unit 109 becomes an admissible estimate arrival distance.

The distance to arrive at the end vertex becomes a distance equal to or more than the number of alteration procedures computed without reflecting a dependence relationship existing between components (attributes).

Furthermore, as indicated in Expression (1), the estimate arrival distance computation unit 109 finds an estimate arrival distance by computing h_{f}′+min(p, pₘₐₓ)−pₘₐₓ. h_{f}′ in a first term of a right side of Expression (1) is equivalent to the number of alteration procedures computed without reflecting a dependence relationship existing between components (attributes). Moreover, (min(p, pₘₐₓ)−pₘₐₓ) is certain to be 0 or less. Thus, in the present example embodiment, Inequality (3) below is satisfied.

h_{f}′+min(p, pₘₐₓ)−pₘₐₓ≤h_{f}′(distance to arrive at end vertex) Expression (3)

As indicated in Expression (3), the estimate arrival distance found in the present example embodiment is less than or equal to the distance to arrive at the end vertex, and is therefore an admissible estimate arrival distance.

### Description of Advantageous Effects

The estimate arrival distance computation unit 109 according to the present example embodiment computes an estimate arrival distance by reflecting a dependence relationship existing between components (attributes) constituting a system. Thus, the system configuration alteration procedure generation device 100 according to the present example embodiment can generate an alteration procedure of a system configuration at a higher speed than a general system configuration alteration procedure generation device 100.

The reason is as follows. The estimate arrival distance computation unit 109 computes an estimate arrival distance reflecting a dependence relationship, and an estimate arrival distance closer to an arrival distance is thereby computed. Because an estimate arrival distance closer to an arrival distance is computed, a difference is made between estimate arrival distances in a plurality of paths, and a shortest distance vertex selected by the shortest distance vertex selection unit 103 is therefore more limited.

Furthermore, the system configuration alteration procedure generation device 100 according to the present example embodiment can efficiently execute the alteration procedure generation processing by use of A* search algorithm. The reason is as follows. For the alteration procedure generation processing to be efficiently executed, the estimate arrival distance computation unit 109 is required to efficiently compute an estimate arrival distance.

The estimate arrival distance computation unit 109 according to the present example embodiment can independently compute an estimate arrival distance for each attribute included in a vertex, and references other attributes when a dependence relationship exists between attributes. Thus, the estimate arrival distance computation unit 109 does not need to perform a complex search or computation over a plurality of attributes, and can efficiently compute an estimate arrival distance.

### Specific Example

A specific example of the example embodiment according to the present invention is described below with reference to the drawings. In the case considered in the present specific example, a version of an application AP operating on a Web server constituting a Web system illustrated in (a) in FIG. 12 is updated to v2 from v1, i.e., the Ap v2 is substituted for the AP v1. Note that a library lib v2 is required for the operation of the Ap v2, as described above.

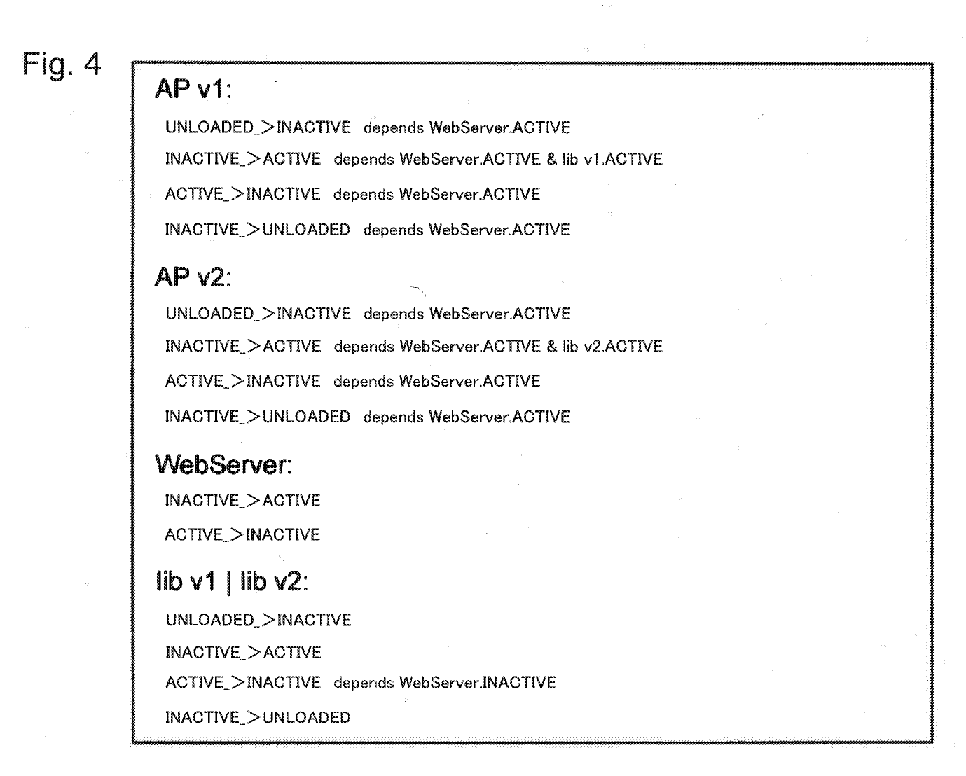

FIG. 4 is an explanatory diagram illustrating a dependence relationship existing between components constituting the Web system illustrated in (a) in FIG. 12. In FIG. 4, there is a description “AP v1: inactive active depends WebServer.active & lib v1.active”. In other words, for the activation of the AP v1, the lib v1 which is a library is required to be in an active state.

Similarly, there is a description “AP v2: inactive active depends WebServer.active & lib v2.active”. In other words, for the activation of the AP v2, the lib v2 which is a library is required to be in an active state. Moreover, for transitions of the state of the AP v1 and the state of the AP v2, the Web server is required to be in an active state. The state of the AP v1 and the state of the AP v2 can take each of the states “inactive”, “active”, “unloaded”.

Furthermore, there is a description “lib v1 llib v2: active→inactive depends WebServer.inactive” in FIG. 4. In other words, for the inactivation of the lib v1 and the lib v2, the Web server is required to be in an inactive state.

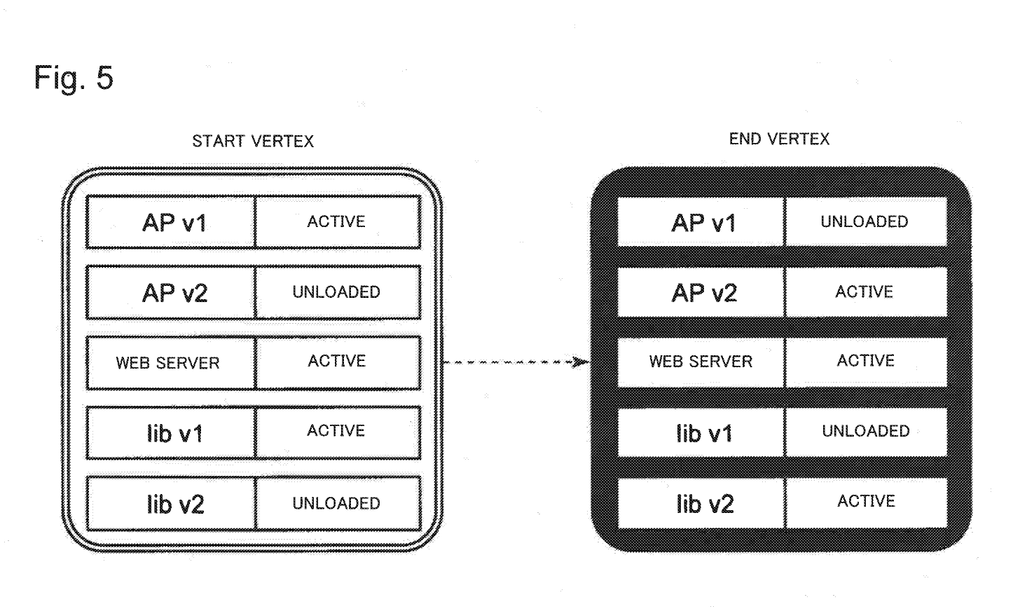

Regarding a system configuration alteration in the present specific example, a start vertex in a state graph representing a system configuration before alteration, and an end vertex in a state graph representing a system configuration after alteration are illustrated in FIG. 5. FIG. 5 is an explanatory diagram illustrating an example of a directed graph representing a definition of a configuration alteration of a system.

As illustrated in FIG. 5, the state “active” of the AP v1 in the start vertex is altered to “unloaded” in the end vertex. Moreover, the state “unloaded” of the AP v2 in the start vertex is altered to “active” in the end vertex.

Furthermore, as illustrated in FIG. 5, the state “active” of the lib v1 in the start vertex is altered to “unloaded” in the end vertex. Moreover, the state “unloaded” of the lib v2 in the start vertex is altered to “active” in the end vertex.

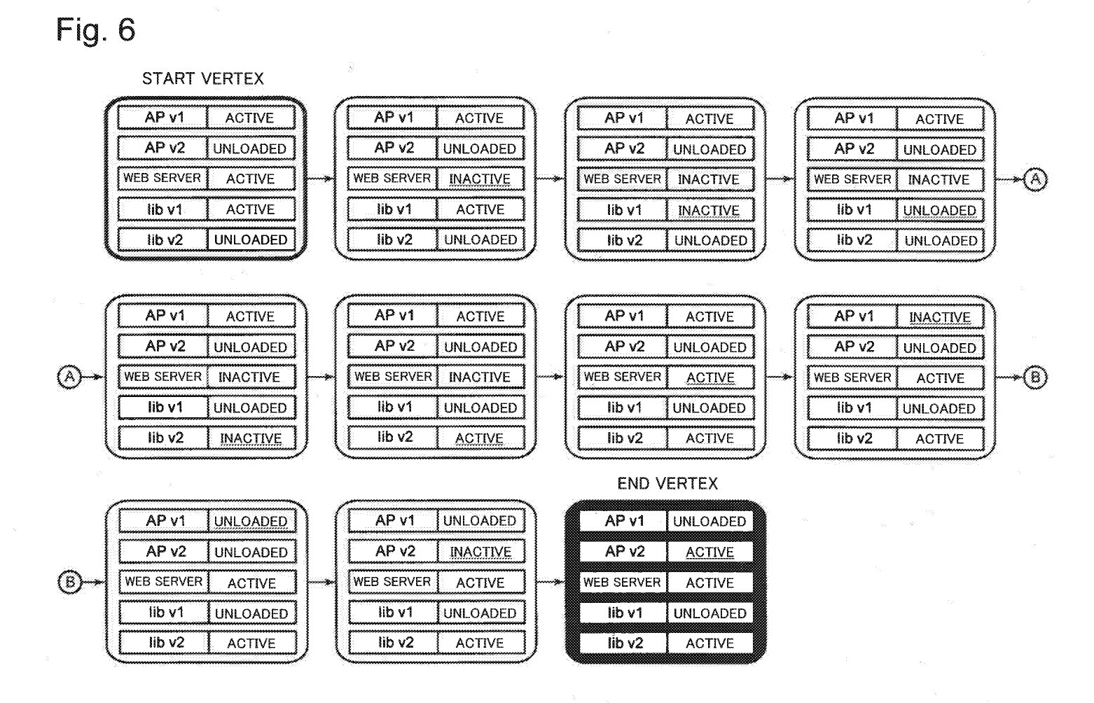

In the alteration procedure generation processing in the present specific example, the system configuration alteration procedure generation device 100 computes a shortest path linking the start vertex and the end vertex illustrated in FIG. 5. FIG. 6 is an explanatory diagram illustrating an example of a shortest path linking the start vertex and the end vertex illustrated in FIG. 5. In the present specific example, the system configuration alteration procedure generation device 100 computes a shortest path as illustrated in FIG. 6.

In each vertex illustrated in FIG. 6, an underlined state represents a state altered from the state in the previous vertex. For example, the state “active” of the Web server in the start vertex is altered to “inactive” in the second vertex.

As illustrated in FIG. 6, the shortest path linking the start vertex and the end vertex illustrated in FIG. 5 is a path constituted by 11 vertexes. Described below is a difference between the case where Manhattan distance is used for an estimate arrival distance in calculation processing of a shortest distance illustrated in FIG. 6, and the case where a distance computed by the estimate arrival distance computation unit 109 according to the present example embodiment is used.

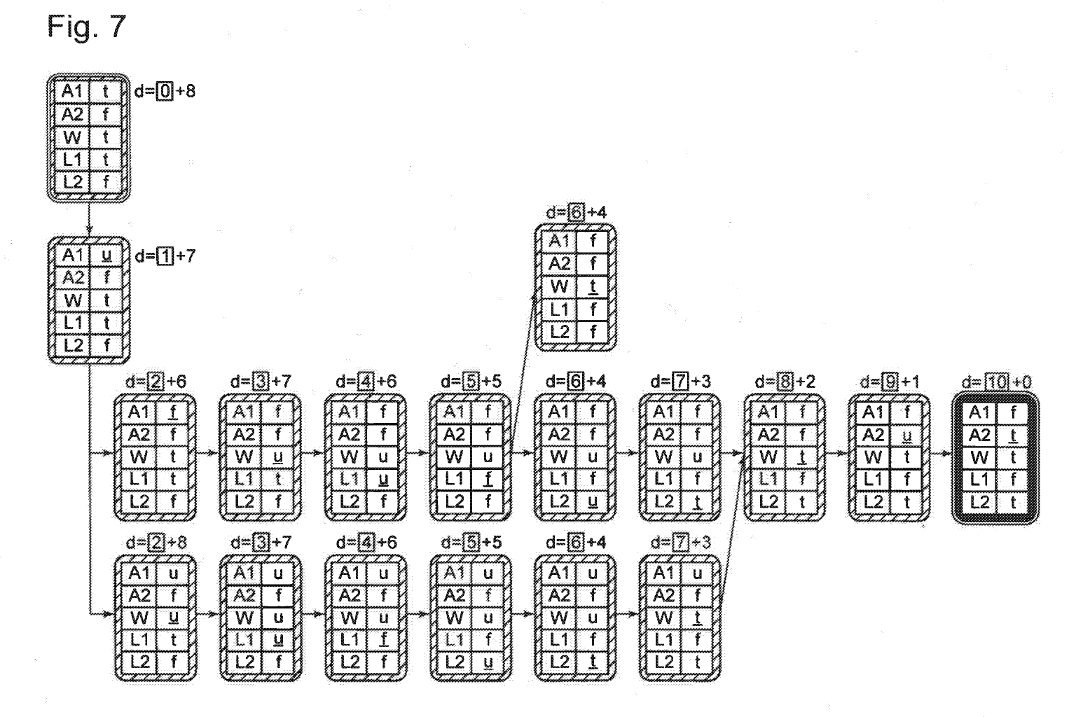

FIG. 7 is an explanatory diagram illustrating an example of search processing of a shortest path illustrated in FIG. 6. The example illustrated in FIG. 7 is an example of search processing of a shortest path when A* search algorithm that uses Manhattan distance for an estimate arrival distance is executed.

When Manhattan distance is used for an estimate arrival distance, the estimate arrival distance is a sum total of the number of operations per attribute that are required for alteration of an attribute value of an attribute of a vertex to an attribute value of an attribute of an end vertex. In other words, the estimate arrival distance in the example illustrated in FIG. 7 is equivalent to a distance computed by the estimate arrival distance computation unit 109 under a condition of pₘₐₓ=0.

Each vertex illustrated in FIG. 7 includes an attribute and a state of the attribute. “A1”, “A2”, “w”, “L1”, and “L2” which are attributes of each vertex represent the AP v1, the AP v2, the Web server, the lib v1, and the lib v2, respectively. Moreover, “t”, “f”, and “u” which are the respective states of an attribute represent “active”, “unloaded”, and “inactive”, respectively.

Furthermore, in each vertex illustrated in FIG. 7, an underlined state represents a state altered from the state in the previous vertex. For example, the state “t” of the attribute “A1” in the start vertex is altered to “u” in the second vertex.

Still further, a letter d described in the vicinity of each vertex illustrated in FIG. 7 represents a distance to a computed end vertex. In the distance, a value surrounded by a rectangle represents a determinate distance. Moreover, another value represents an estimate arrival distance. As described above, the estimate arrival distance in the example illustrated in FIG. 7 is Manhattan distance.

Yet further, a shaded vertex in FIG. 7 represents a vertex retrieved on the algorithm. Along with the flowchart illustrated in FIG. 17, the general system configuration alteration procedure generation device 100 illustrated in FIG. 14 retrieves a vertex until a shortest distance vertex is included in an end vertex. In the example illustrated in FIG. 7, all 18 vertexes are retrieved.

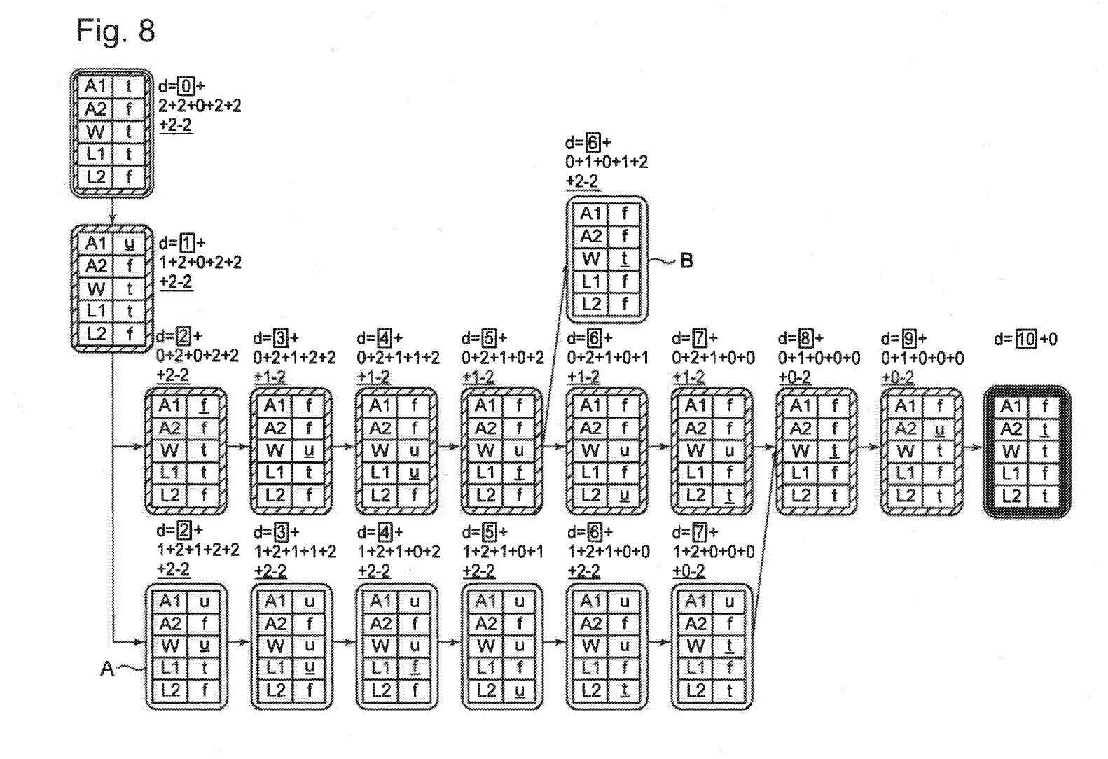

FIG. 8 is an explanatory diagram illustrating another example of search processing of a shortest path illustrated in FIG. 6. The example illustrated in FIG. 8 is an example of search processing of a shortest path in the case where A* search algorithm that uses, for an estimate arrival distance, a distance computed by the estimate arrival distance computation unit 109 according to the present example embodiment is executed. In addition, FIG. 8 illustrates an example of search processing of a shortest path executed under a condition of pₘₐₓ=2.

A letter d described in the vicinity of each vertex illustrated in FIG. 8 represents a distance to a computed end vertex. In the distance, a value surrounded by a rectangle represents a determinate distance. Moreover, another value represents an estimate arrival distance. An underlined value in the estimate arrival distance represents a penalty part, i.e., a value of min(p, pₘₐₓ)−pₘₐₓ in Expression (1). In addition, another value of the estimate arrival distance represents a distance for each attribute.

As illustrated in FIG. 8, d which represents the estimate arrival distance in the start vertex includes an expression “2+2+0+2+2”. The expression “2+2+0+2+2” is a distance represented by a sum of the number of operations of each of attributes “A1”, “A2”, “w”, “L1”, and “L2”. For example, a state of “A1” in the start vertex is “t”, and a state of “A1” in the end vertex is “f”. Accordingly, a distance of “A1” in the start vertex is 2 which is the number of operations that are required for alteration from the state “t” to the state “f”.

In other words, the expression “2+2+0+2+2” is an expression in which the respective distances of the five attributes computed as described above are added together. Note that “8” which is a computation result of the expression “2+2+0+2+2” is described in FIG. 7.

Meanings of indications in FIG. 8 other than d are the same as meanings of indications in FIG. 7. Along with the flowchart illustrated in FIG. 2, the system configuration alteration procedure generation device 100 according to the present example embodiment illustrated in FIG. 1 retrieves a vertex until a shortest distance vertex is included in an end vertex. In the present specific example, retrieval is performed from a vertex having the smallest distance d on the algorithm.

A white vertex is indicated in FIG. 8. The white vertex represents a vertex that is not retrieved on the algorithm. The reason that the white vertex is not retrieved is that the distance d thereof is greater than those of all vertexes that are retrieved. For example, a vertex A illustrated in FIG. 8 has a distance d of 10.

Because a vertex having a distance d of 10 or more is the end vertex alone among the vertexes that are retrieved, the vertex A having a distance d of 10 is not retrieved unless the distances d of the other vertexes become more than 10. Because the vertex A is not retrieved, other vertexes constituting the same path are not retrieved either. Moreover, for a reason similar to that of the vertex A, a vertex B is not retrieved either.

In the example illustrated in FIG. 8, 11 vertexes including a start vertex and an end vertex are retrieved. In other words, in the example illustrated in FIG. 8, the vertex (white vertex) that is not retrieved until the end exists, and the search processing is therefore executed at a higher speed than in the example illustrated in FIG. 7. Thus, the system configuration alteration procedure generation device 100 according to the present example embodiment can more efficiently find a shortest path than the general system configuration alteration procedure generation device 100.

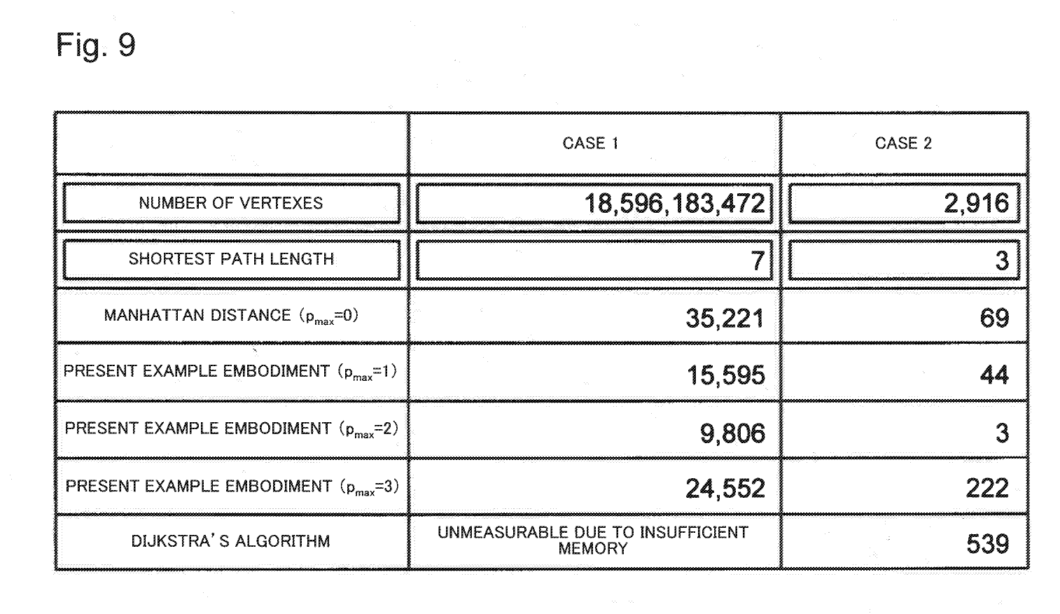

FIG. 9 is an explanatory diagram illustrating an evaluation result of search processing of a shortest path executed on the basis of each scheme. Case 1 is an example having a large number of vertexes to be retrieved. Moreover, Case 2 is an example having a small number of vertexes to be retrieved. In addition, a number described in a shortest path length represents the number of links. The number of links is ((number of vertexes constituting shortest path) −1).

FIG. 9 illustrates, for Case 1 and Case 2, the respective numbers of vertexes that are retrieved when Manhattan distance, a distance computed by the estimate arrival distance computation unit 109, and Dijkstra's algorithm are used. Regarding the case where the distance computed by the estimate arrival distance computation unit 109 is used, cases where computations are performed under each of conditions pₘₐₓ=1, pₘₐₓ=2, and pₘₐₓ=3 are illustrated, respectively.

FIG. 9 illustrates an evaluation result indicating that, in both Case 1 and Case 2, the number of retrieved vertexes is the smallest when the distance computed by the estimate arrival distance computation unit 109 is used under the condition of pₘₐₓ=2. Thus, the system configuration alteration procedure generation device 100 according to the present example embodiment when pₘₐₓ=2 is set can search for a shortest path at the highest speed.

The system configuration alteration procedure generation system according to the present example embodiment has the estimate arrival distance computation unit which efficiently computes an appropriate estimate arrival distance used to generate a configuration alteration procedure of an ICT system. The estimate arrival distance computation unit computes an estimate arrival distance reflecting a dependence relationship existing between modules constituting the ICT system in a state graph which is a directed graph representing a configuration alteration of the ICT system.

When given the current system configuration and a system configuration to which to be altered, the system configuration alteration procedure generation system according to the present example embodiment can generate a configuration alteration procedure at a higher speed than in the case where Manhattan distance is used for an estimate arrival distance.

The reason is that the estimate arrival distance computation unit computes an estimate arrival distance reflecting a dependence relationship existing between modules constituting the ICT system, and an estimate arrival distance closer to an arrival distance is thereby computed. Because an estimate arrival distance closer to an arrival distance is computed, a difference is made between estimate arrival distances in a plurality of paths, and the system configuration alteration procedure generation system can discover a shortest distance path by use of A* search algorithm at a higher speed.

Note that the system configuration alteration procedure generation device 100 according to the present example embodiment is realized by, for example, a central processing unit (CPU) which executes processing in accordance with a program stored in a storage medium. In other words, the shortest distance vertex selection unit 103, the shortest path acquisition unit 107, the state graph expansion unit 108, and the estimate arrival distance computation unit 109 are realized by, for example, the CPU which executes processing under program control.

Moreover, the under-retrieval vertex table storage unit 104, the retrieved vertex table storage unit 105, and the path tree information storage unit 106 are realized by, for example, a random access memory (RAM).

Alternatively, each part in the system configuration alteration procedure generation device 100 according to the present example embodiment may be realized by a hardware circuit.

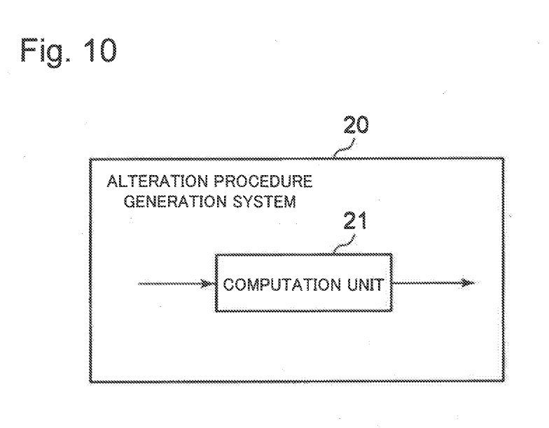

Next, an overview of the present example embodiment is described. FIG. 10 is a block diagram illustrating an overview of an alteration procedure generation system according to the present example embodiment. An alteration procedure generation system 20 according to the present example embodiment includes a computation unit 21 (e.g., estimate arrival distance computation unit 109) which adds, to a sum total of the number of procedures per attribute that are required for alteration of an attribute value of an attribute constituting a system in a predetermined state to an attribute value of the attribute constituting the system in a state to which to be altered, the number of attributes less than a predetermined value at which the attribute values of other attributes are altered by the alteration, and subtracts the predetermined value from the sum total, thereby computing an estimate arrival distance.

With such a configuration, the alteration procedure generation system can appropriately generate an alteration procedure of a system in which a dependence relationship exists between attributes constituting the system.

Furthermore, the computation unit 21 may obtain, as an input, an adjacent vertex representing a system in a predetermined state, and an end vertex representing the system in a state to which to be altered, and compute an estimate arrival distance regarding the adjacent vertex by use of Manhattan distance from the adjacent vertex to the end vertex equivalent to the sum total of the number of procedures per attribute.

With such a configuration, the alteration procedure generation system can generate an alteration procedure of a system by obtaining, as an input, a state graph representing a state of the system to which to be altered.

Furthermore, the alteration procedure generation system 20 includes a selection unit (e.g., shortest distance vertex selection unit 103) which selects a shortest distance vertex. The computation unit 21 computes a determinate distance from a start vertex representing a system in an initial state to an adjacent vertex. The selection unit may obtain, as an input, the adjacent vertex, and the determinate distance and the estimate arrival distance regarding the adjacent vertex, and select, as the shortest distance vertex, an adjacent vertex in which a sum of the determinate distance and the estimate arrival distance is the shortest among the input adjacent vertexes.

With such a configuration, the alteration procedure generation system can select a shortest distance vertex on the basis of an estimate arrival distance computed in consideration of a dependence relationship existing between attributes constituting a system.

Furthermore, the alteration procedure generation system 20 may include an acquisition unit (e.g., shortest path acquisition unit 107) which acquires, as a shortest path, a path constituted by the plurality of shortest distance vertexes selected by the selection unit.

With such a configuration, the alteration procedure generation system can acquire a shortest alteration procedure of a system on the basis of an estimate arrival distance computed in consideration of a dependence relationship existing between attributes constituting a system.

Furthermore, the alteration procedure generation system 20 may include a display unit (e.g., display unit 200) which displays the shortest path acquired by the acquisition unit.

With such a configuration, the alteration procedure generation system can present the acquired alteration procedure of the system to a user in a way easy to understand.

Moreover, the predetermined value may be 2.

With such a configuration, the alteration procedure generation system can generate an alteration procedure of a system at a higher speed.

### Industrial Applicability

The present invention is suitably applicable to a purpose of finding a configuration alteration procedure of a system constituted by components having a dependence relationship. The present invention is also suitably applicable to a purpose of generating a procedure of a process constituted by operations having a dependence relationship.

This application is based upon and claims the benefit of priority from Japanese patent application No. 2016-021604, filed on Feb. 8, 2016, the disclosure of which is incorporated herein in its entirety by reference.

### Reference Signs List

10 System configuration alteration procedure generation system
20 Alteration procedure generation system
21 Computation unit
100 System configuration alteration procedure generation device
101 Adjacent vertex acquisition unit
102, 109 Estimate arrival distance computation unit
103 Shortest distance vertex selection unit
104 Under-retrieval vertex table storage unit
105 Retrieved vertex table storage unit
106 Path tree information storage unit
107 Shortest path acquisition unit
108 State graph expansion unit
200 Display unit

What is claimed is:

1. An alteration procedure generation system comprising:
a memory storing instructions; and
one or more processors configured to execute the instructions to:
compute an estimate arrival distance by
adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and
subtracting the predetermined value from the sum total.

2. The alteration procedure generation system according to claim 1, wherein
the one or more processors are further configured to execute the instructions to:
acquire, as an input, an adjacent vertex representing the system in the predetermined state, and an end vertex representing the system in the targeted state, and computes an estimate arrival distance regarding the adjacent vertex by use of Manhattan distance from the adjacent vertex to the end vertex being equivalent to the sum total of the number of the procedures per attribute.

3. The alteration procedure generation system according to claim 2, wherein:
the one or more processors are further configured to execute the instructions to:
select a shortest distance vertex, wherein vertex;
compute a determinate distance from a start vertex representing the system in an initial state to the adjacent vertex, and
acquire, as an input, the adjacent vertex, and the determinate distance and the estimate arrival distance regarding the adjacent vertex, and select, as the shortest distance vertex, an adjacent vertex in which a sum of the determinate distance and the estimate arrival distance is shortest out of the input adjacent vertexes.

4. The alteration procedure generation system according to claim 3, wherein:
the one or more processors are further configured to execute the instructions to:
acquire, as a shortest path, a path constituted by a plurality of the shortest distance vertexes selected.

5. The alteration procedure generation system according to claim 4, wherein:
the one or more processors are further configured to execute the instructions to:
display the acquired shortest path.

6. The alteration procedure generation system according to claim 1, wherein
the predetermined value is 2.

7. An alteration procedure generation method comprising:
computing an estimate arrival distance by
adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and
subtracting the predetermined value from the sum total.

8. The alteration procedure generation method according to claim 7, further comprising:
acquiring, as an input, an adjacent vertex representing the system in the predetermined state, and an end vertex representing the system in the targeted state, and computing an estimate arrival distance regarding the adjacent vertex by use of Manhattan distance from the adjacent vertex to the end vertex being equivalent to the sum total of the number of the procedures per attribute.

9. A non-transitory computer readable program storage medium storing a program that causes a computer to execute:
a computation process of computing an estimate arrival distance by
adding a number of attributes being the number less than a predetermined value, to a sum total of a number of procedures per attribute, the procedures being required for an alteration of an attribute value of an attribute constituting a system in a predetermined state to an attribute value of the attribute constituting the system in a targeted state, the attributes having attribute values of other attributes altered by the alteration, and
subtracting the predetermined value from the sum total.

10. The non-transitory computer readable program storage medium according to claim 9, further causing a computer to execute:
a computation processing of acquiring, as an input, an adjacent vertex representing the system in the predetermined state, and an end vertex representing the system in the targeted state, and computing an estimate arrival distance regarding the adjacent vertex by use of Manhattan distance from the adjacent vertex to the end vertex being equivalent to the sum total of the number of the procedures per attribute.
